(19) United States
(12) Patent Application Publication
(10) Pub. No.: US 2025/0178072 A1
(43) Pub. Date: Jun. 5, 2025

(54) METHOD FOR PRODUCTION OF A STAINLESS HIGH-STRENGTH SELF-DRILLING SCREW

(71) Applicant: SFS Group International AG, Heerbrugg (CH)

(72) Inventors: Marc COMOTH, Donzere (FR); Hanspeter KUSTER, Balgach (CH); Sven SPIRIG, Diepoldsau (CH)

(73) Assignee: SFS Group International AG, Heerbrugg (CH)

(21) Appl. No.: 18/960,019

(22) Filed: Nov. 26, 2024

(30) Foreign Application Priority Data
Nov. 30, 2023 (EP) 23213364.5

(51) Int. Cl. B21K 1/56

(52) U.S. Cl. CPC B21K 1/56

(57) ABSTRACT

A method for producing an entirely stainless steel, high-strength self-drilling screw that does not need heat treatment downstream of manufacturing to improve material hardness. A stainless steel wire section blank is provided. A screw head is cold-formed at a first end. Subsequently, the diameter at the second end section is reduced by cold forming. A drill tip is produced at the second end by a tweaking movement transverse to the longitudinal axis. Subsequently, the drill tip is finished. Any protruding material flags remaining on the drill tip cutting edges are sheared off during subsequent thread rolling. During preforming, contour edges are formed in the region of the subsequent cutting edges, with the remaining material thickness between 0.3 mm and 1.0 mm. The drill tip final forming forms these contour edges into the cutting edges, and the remaining material thickness between the cutting edge and the material flag is between 0.05 mm and 0.2 mm.

### CROSS-REFERENCE TO RELATED APPLICATIONS

This application claims priority from European Patent Application No. 23213364.5, filed Nov. 30, 2023, which is incorporated herein by reference as if fully set forth.

### TECHNICAL FIELD

The present invention relates to a method for the production of a high-strength fastener made of stainless steel, in particular a self-drilling screw, and to a self-drilling screw produced in this way.

### BACKGROUND

Steel is usually defined as an iron-carbon alloy with a carbon content of no more than 2%. Carbon steel or unalloyed steel is the term used to describe variants that contain only minor impurities or no specifically added alloy components such as chromium, nickel, copper, manganese or silicon. Rust-resistant steels, often also referred to as stainless steels, are characterized by an alloy content of >10% chromium and less than 1.2% carbon.

Due to the incorporation of carbon into the matrix of the steel lattice, carbon steel is generally easier to harden than stainless steels. This hardening is usually achieved by hardening processes (heat treatment, case hardening such as carbonitriding) or cold forming processes. However, this—generally desirable—hardness of the steel comes at the price of the fundamental disadvantage of susceptibility to corrosion. For this reason, certain end products require post-treatment (coating, passivation) to make them resistant to environmental influences within certain limits.

Among stainless steels, the most common are those with the alloy components chromium and nickel, such as steel grades 1.4301 (V2A or A2) and 1.4401 (V4A or A4). Standards exist for these steels with specified compositions, so that these grades with comparable properties can be obtained from various sources. These steels are also referred to as austenitic because the alloy components Ni, C, Mn and N stabilize the austenite phase in the steel during production.

Duplex steel is a steel with a two-phase structure consisting of a ferrite matrix with islands of austenite. Compared to purely austenitic steels, duplex steel has a lower nickel content, which means that the entire microstructure does not become austenitic at room temperature. Examples of this are the grades 1.4462 and 1.4362.

Many everyday products and construction industry products are made of steel, including fasteners such as screws in all conceivable sizes for many applications. It would often be desirable to combine the hardness of carbon steel with the corrosion resistance of stainless steel. This is usually achieved, particularly with drilling screws, by welding a carbon steel wire section to a stainless steel wire of the same diameter and processing such a blank into a fastener in a known manner. The rolled or formed carbon steel tip can be hardened by heat treatment, while the stainless steel shank can usually remain untreated, which also preserves the corrosion-inhibiting properties of the steel.

In this document, a fastener is a mechanical component that can be used to permanently connect two components to one another (both detachable and non-detachable). A screw is specifically defined as a fastener that has an essentially longitudinally extended shank with a cylindrical or cylinder-like cross-section. At one longitudinal end of the shank there is a force application, which can be designed as a head with force application surfaces. The tip of the screw is located at the opposite end of the shank. The shank is provided with a thread in at least one section; it can be single or multi-start with a constant or variable pitch. The tip can be designed as a drill tip with cutting edges, as a blunt tapered, threadless displacement tip or as a pointed tapered tip that forms holes and threads itself. Depending on the application, the thread can extend from the shank to the cone or the screw tip.

A drilling screw is a screw with a drill tip with cutting edges, in which the (shank) thread is rolled and the drill tip is tweaked. Tweaking is a special type of cold forming in which a shank end of the blank is pressed into the desired shape of a drill tip by two tapered knives. Other cold forming processes include rolling, upsetting, drawing and extrusion. Basically, the person skilled in the art understands cold forming to be the plastic forming of metals below the recrystallization temperature, which is known to lead to work hardening of the formed material.

The production of fasteners or screws purely from stainless steels is well known; however, the penetration capability of steel with corresponding (self-) drilling screws or hole- and thread-forming screws is limited. Bimetal screws are complex to manufacture and expensive to produce. There is therefore a need for fasteners, in particular screws or self-drilling screws, which can be manufactured entirely from a corrosion-resistant steel grade and can still penetrate steel sheets>1.5 mm thick without pre-drilling.

### DESCRIPTION OF THE PRIOR ART

The disclosure document DE 29 29 179 describes a corrosion-resistant, self-drilling and thread-forming screw made of a stainless austenitic steel material (according to US standard series 300). The method steps in the production comprise the upsetting of a head at the end of a wire section of the said material and subsequently, at the opposite end, the formation of a drill tip by a tweaking process with a defined maximum closing speed of the knives. This transforms the austenitic structure of the drill tip into a martensitic one. The document also recommends cooling the press blank to temperatures below 0° C., e.g. using dry ice.

The specification EP 2 080 572 describes the manufacture of a high-strength fastener made of austenitic steel of the 300 series (according to the US standard) by reducing the diameter of a shank blank by 15% by cold forming in a first step. The head and tip are then also produced by cold forming. The thread is produced on the shank by a rolling process. It is also proposed to improve the rust resistance of the cold-formed fastener by post-treatment or coating.

The specifications DE 2 103 053 and U.S. Pat. No. 3,683,436 describe the manufacture of a drilling screw with a tweaked drill tip. The wire blank is reduced in diameter at one end by extrusion and then shaped into its final form by tweaking.

EP 2 617 500 A1 describes the manufacture of a one-piece stainless steel drilling screw in which the drill tip is produced in two forming steps. In a first step, an end section of a blank is flattened and then the flattened end section is formed into the final drill tip.

### SUMMARY

It is the object of the present invention to improve the methods described, in particular to propose method steps for the production of a corrosion-resistant, hole-forming and thread-forming screw with a drill tip which makes the use of bimetallic screws largely superfluous.

This object is achieved with one or more of the features disclosed hereon. Advantageous embodiments of the invention are given below and in the claims.

In the following, the manufacturing process of a self-drilling screw according to the present invention is described as a sequence of process steps. In terms of production technology, these represent a consecutive series of work steps that are usually carried out in quick succession. As a rule, multi-stage cold forming machines are used for production, which bring a workpiece into the desired shape with the aid of various tools in a synchronized manner and at defined forming rates. Intermediate steps in the process chain such as quality control, transportation, cleaning, sorting and packaging are not mentioned and have no influence on the feasibility of the invention.

The self-drilling screw according to the present invention is manufactured entirely from a stainless steel material and achieves its high strength even without a heat treatment process following production steps A-F that specifically improves the material hardness. Such a process is therefore expressly excluded. The advantage lies in time and energy savings.

### Step A:

This process step involves the provision of a wire section which, as is known in the prior art, can be produced as a piece from a wire coil or as a section from a corresponding bar of stainless steel material. In the following, this is also referred to as a blank. The section can be obtained in a known manner by shearing, sawing or in another way from the primary material. The length and diameter of the blank depend on the planned dimensions of the self-drilling screw to be produced; the design is based on the known rules of the prior art.

### Step B:

Upsetting of a screw head by cold forming at a first longitudinal end of the blank. The upsetting of the screw head can also take place in one or more intermediate steps in order to control the degree of forming per upsetting process. The production of a force application (hexagon socket, hexalobular socket, hexagon socket, . . . ) on or in the screw head is included in step B.

### Step C:

Reducing the diameter of a (longitudinal) section or shank section at the second longitudinal end of the blank by cold forming. The diameter is reduced at the second longitudinal end opposite the screw head. This increases the surface hardness and lengthens the relevant section. This diameter reduction can also be carried out in several partial steps; this variant is equivalently included in step C.

The length of the shank section will include at least the (longitudinal) section that is provided in the subsequent steps D and E for the production of the drill tip. However, if necessary, it can also include the shank section intended for the thread on the shank. The diameter reduction can also include the entire length of the shank up to below the head if this is useful or sensible in terms of production technology.

### Step D:

Preforming a drill tip at the second longitudinal end of the blank by a tweaking movement transverse to the longitudinal axis between two opposing tool jaws. The second longitudinal end of the blank, which is tapered in diameter in step C, is preformed. In this context, preforming means that two so-called knives, i.e. tool halves of a tweaking device, bring the longitudinal end of the blank into a preform that is recognizable as a drill tip but does not correspond to the final dimensions.

The resulting preform encloses material flags created during this pressing process, which are formed from excess material displaced outwards. The preformed drill tip is thus surrounded by a flat, thin, irregularly shaped material disk. The plane of the material disk corresponds to the closing plane or closing surface defined by the two tapered tool jaws.

Preforming the drill tip also means that the main cutting edges, transverse cutting edges, chip flutes and flanks of the future drill tip, depending on the selected drill tip layout, are identifiable in their shape and position, but do not yet correspond to the final dimensions. The tool jaws are usually designed in such a way that the future cutting edges are at least partially located in the material disk and are already marked by embossed contour edges during preforming.

### Step E:

Final forming of the drill tip. In a further cold forming step, the main cutting edges, transverse cutting edges, chip flutes and flanks of the drill tip are finished in terms of shape and position according to the specific design, thus achieving the intended final dimensions. The contour edges are further shaped and—depending on the requirements—become cutting edges. In this step, the aforementioned material disk is further thinned out and can be partially perforated or present along the contour edges or finally formed cutting edges.

### Step F:

The protruding material flags remaining on the cutting edges or contour edges of the drill tips are sheared off during a subsequent thread rolling process. The thread on the shank can be applied over the full length between the screw head and the drill tip or also on partial areas, depending on the design.

The invention is characterized in steps D and E in that
contour edges are formed in the region of the subsequent cutting edges during preforming in step D, wherein the remaining material thickness between the contour edge and the material flag is between 0.3 mm (incl.) and 1.0 mm (excl.). These contour edges are recognizable as notches in the blank between the intended drill tip and the material flags.
after the final forming in step E, the contour edges are formed into cutting edges and the remaining material thickness between the cutting edge and the material flag is between 0.05 mm (incl.) and 0.3 mm (incl.), wherein local breakthroughs are also possible (perforation). This means that in some areas the cutting edges are already separated from the material flags.

Preferably, the final forming of the drill tip in step E is carried out in the same way as step D by a tweaking movement of two opposing tool jaws transverse to the longitudinal axis of the blank. In order to achieve the effect described in steps D and E and to simplify tool manufacture, the tool jaws used in steps D and E are similar in shape but not identical. Shape-like is thus to be seen in contrast to the preforms known in the prior art, which only provide for flattening, flattening out or a purely cylindrical blank shape. The tools used in step D, on the other hand, achieve a result that already resembles a drill tip, but would not yet be usable as such.

This design ensures that the final step, which gives the drill tip its final shape, remains a forming process with a lower degree of deformation and therefore generates less forming heat. The work hardening achieved is retained in the cutting edges.

The forming heat generated during preforming can flow better into the surrounding material disk or material flags due to the only pre-stamped contour edges and reduces the tendency for recrystallization of the steel structure.

As mentioned at the beginning, the method presented allows advantageous use with many stainless steel materials. These include stainless steels of the standards 1.4301, 1.4551 or 1.4307 (V2A), or 1.4401, 1.4571 or 1.4404 (V4A) or 1.4462, 1.4410 or 1.4501 (duplex). Similar steel grades from other standards are included as equivalent.

It is particularly advantageous to use stainless steel material as a starting material that already has a surface strength of between 200 and 350 Hv before processing according to step A.

The diameter reduction explained in step C is advantageously at least 20% and at most 40%. Within the scope of the invention, forming in several partial steps is also included.

The cold forming steps A to F described above are advantageously followed by a coating to further improve the usability of the screw. An electroplated Zn—Ni coating has proven to be particularly effective. This process step is summarized under step G. Preferably, the Zn—Ni coating from step G will contain 12-15% nickel.

In a further process step H, a single or multi-layer sliding coating made of wax, plastics or mixtures thereof can be applied to the Zn—Ni coating according to step G. Such coatings have a friction-reducing effect, particularly on the drill tip and its cutting edges.

A particularly efficient additional step to ensure the high strength of the self-drilling screw described here is to carry out a cooling process of the blank between preforming (step D) and final forming (step E) of the drill tip.

It has been shown that both active cooling of the blank by means of a cooling fluid and passive cooling of the blank in a temperature-controlled environment are effective. The cooling fluid can be a liquid medium that is sprayed, injected or pumped over the blank. It can also be an immersion process, a bath or an equivalent cooling method. Gaseous media, cooling air or ambient air cooled by dry ice are also effective.

Passive cooling is understood as the release of heat from the blank into the environment without targeted cooling measures until the desired final temperature is reached. It has been shown that cooling down to normal ambient temperatures involves the least effort. In any case, cooling should take place to temperatures below 100° C., preferably below 50° C.

It has been shown that the surface hardness of the blank after step C in the area formed thereby is substantially 300-380 Hv as a result of the inventive method. If a cooling process is carried out between steps D and E as described above, the surface hardness of the blank after the cooling process (measured after step E in the region formed as a result of the cooling process) can be increased substantially to 450-550 Hv.

A high-strength self-drilling screw can therefore be manufactured in one piece from stainless steel using a method as described above.

### BRIEF DESCRIPTION OF THE FIGURE

FIGS. 1A-1F shows a sequence of production stages A to F analogous to the process steps described.

### DETAILED DESCRIPTION

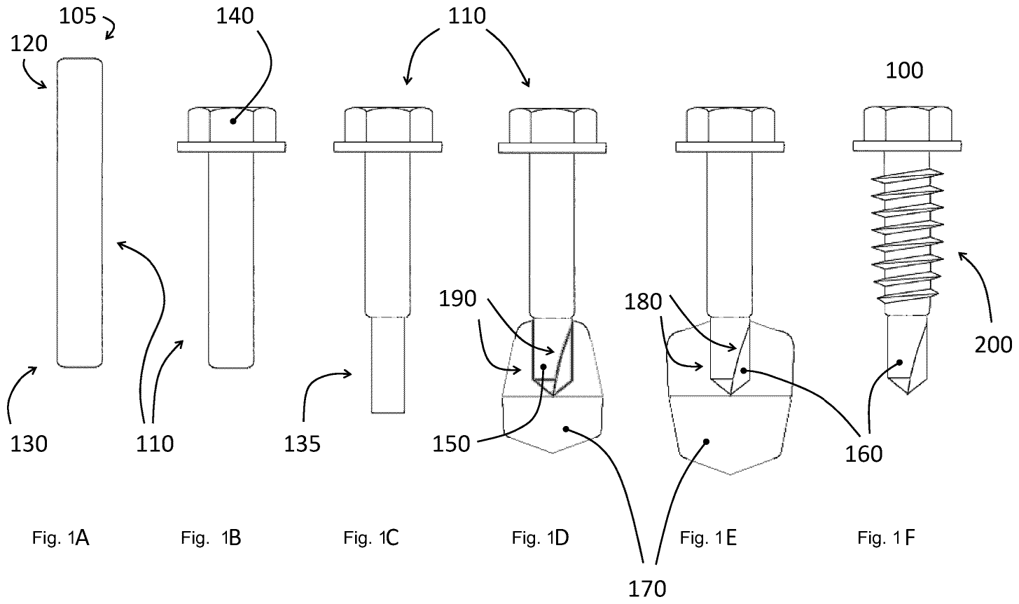

FIGS. 1A-1F shows the sequence of the core method steps A-F described in the invention.

FIG. 1A shows a wire section 105 with a first longitudinal end 120 and a second longitudinal end 130. In step B, FIG. 1B, this blank 110 is given a screw head 140 by cold forming. The type of screw head 140 shown is representative of all types of technically useful screw heads. FIG. 1C shows an (end) section 135 of blank 110 that has been tapered by cold forming.

FIG. 1D shows the state of the blank 110 after the preforming of the drill tip 150. The contour edges 190 are shown as broad lines. These contour edges shown correspond to one way of forming a drill tip, a large number of which are known in the prior art. Where the contour edge 190 and the material flag 170 meet, the claim criterion “remaining material thickness” is applicable. Furthermore, any edge of the drill tip design that is formed is also considered a contour edge, even if it is not in the material disk or plane of the material flag. For these contour edges, the claim criterion “remaining material thickness” is logically not applicable.

In FIG. 1E, the state after the final forming is shown with thin lines for the cutting edges 180, which have emerged from the contour edges 190. The aforementioned claim criterion “remaining material thickness” is applicable to the cutting edges 180 that adjoin the material flag 170. As can be seen, the material flag 170 has been enlarged by the second forming. The permissible perforation is not shown here.

FIG. 1F shows the finished cold-formed self-drilling screw 100 with thread 200 and drill tip 160 freed from the material flag 170.

The term blank is used in this section as a collective term for all manifestations of the self-drilling screw from steps A to (and including) E, even if the external appearance of the screw changes from step to step.

1. A method for production of a high-strength self-drilling screw (100) made entirely from a stainless steel material, in which the self-drilling screw (100) does not undergo a heat treatment process downstream of the manufacturing process to improves material hardness, the method comprising the following steps:
A) providing a shank-shaped blank (110) as a wire section (105) made of the stainless steel material;
B) upsetting of a screw head (140) by cold forming at a first longitudinal end (120) of the blank (110);
C) reducing a diameter of a section (135) at a second longitudinal end (130) of the blank (110) by cold forming;
D) preforming of a drill tip (150) at the second longitudinal end (130) of the blank (110) by a tweaking movement transverse to a longitudinal axis between two opposing tool jaws;
E) final forming of the drill tip (160);
F) shearing off of protruding material flags (170) remaining on cutting edges (180) of the drill tip (160) during a subsequent thread rolling process;
wherein the method further includes
forming contour edges (190) during preforming in step D in a region of where the cutting edges (180) are subsequently formed, wherein a remaining material thickness between the contour edge (190) and the material flags (170) is between 0.3 mm and 1.0 mm; and
after the final forming in step E, forming the contour edges (190) into the cutting edges (180) such that a remaining material thickness between the cutting edge (180) and the material flag (170) is between 0.05 mm and 0.3 mm, with local breakthroughs being allowed.

2. The method according to claim 1, wherein the stainless steel material is a stainless steel selected from the standards 1.4301, 1.4551 or 1.4307 (V2A), or 1.4401, 1.4571 or 1.4404 (V4A) or 1.4462, 1.4362, 1.4410 or 1.4501 (duplex).

3. The method according to claim 1, wherein the stainless steel material at a start of the method has a surface strength of between 200 and 350 Hv before processing according to step A.

4. The method according to claim 1, wherein the reduction in diameter in step C is at least 20% and at most 40%.

5. The method according to claim 1, wherein the final forming of the drill tip in step E is effected by a tweaking movement of two opposing tool jaws transverse to the longitudinal axis of the blank.

6. The method according to claim 5, wherein the two opposing tool jaws used in step D and E are not identical.

7. The method according to claim 1, further comprising:
G) applying an electroplated Zn—Ni coating after the cold forming steps A to F.

8. The method according to claim 7, wherein the Zn—Ni coating from step G contains 12-15% nickel.

9. The method according to claim 7, further comprising:
H) applying a single-layer or multi-layer sliding coating made of wax, plastics or mixtures thereof onto the Zn—Ni coating applied in step G.

10. The method according to claim 1, further comprising:
carrying out a cooling process for the blank between the preforming in step D and the final forming in step E of the drill tip.

11. The method according to claim 10, wherein the cooling process is effected by active cooling of the blank by a cooling fluid.

12. The method according to claim 10, wherein the cooling process is carried out by passively cooling the blank in a temperature-controlled environment.

13. The method according to claim 1, wherein a surface hardness of the blank after step C in a region formed thereby is substantially 300-380 Hv.

14. The method according to claim 10, wherein the surface hardness of the blank after the cooling process and after step E is substantially 450-500 Hv in a region formed thereby.

15. A high-strength self-drilling screw, produced in one piece from stainless steel, by the method according to claim 1.
